(19) United States
(12) Patent Application Publication
(10) Pub. No.: US 2003/0007911 A1
(43) Pub. Date: Jan. 9, 2003

(54) HYDROPHOBIC SILICA SYSTEM

(76) Inventors: Dennis M. Le Claire, Milwaukee, WI (US); Paul S. Bradin, Pewaukee, WI (US); Elmer M. Evenson, Marietta, GA (US); Warren F. Jones, Holly Springs, GA (US)

Correspondence Address: Christopher M. Turoski, FOLEY & LARDNER, Firstar Center, 777 East Wisconsin Avenue, Milwaukee, WI, 53202-5367, US

(21) Appl. No.: 09/888,238

(22) Filed: Jun. 22, 2001

(51) Int. Cl. B01L 7/00; B01J 8/00; B01F 3/06; B01F 3/12

(52) U.S. Cl. 422/198; 422/224; 422/190

(57) ABSTRACT

A process for the continuous production of hydrophobic silica is disclosed. The process may include mixing hydrophilic silica with silicone in a mixer thereby forming a mixture. The process may also include heating the mixture in a reactor thereby forming a hydrophobic silica. The hydrophobic silica may be formed continuously by providing the hydrophilic silica and the silicone. A system for the continuous production of hydrophobic silica is also disclosed. The system may include a mixer for mixing the hydrophilic silica and silicone. The system may also include a reactor for heating the hydrophilic silica and the silicone comprising a channel having a plurality of heating zones, wherein the reactor is in fluid communication with the mixer. The system may also include a storage receptacle for storing the hydrophobic silica, wherein the storage receptacle is in fluid communication with the reactor. The system may be configured for the continuous production of the hydrophobic silica by varying the amounts of hydrophilic silica and silicone provided to the mixer.

### FIELD

The present invention relates to a hydrophobic silica system and method. More particularly, the present invention relates to a method of making hydrophobic silica from hydrophilic silica, and a system to make hydrophobic silica from hydrophilic silica.

### BACKGROUND

Silica has the empirical chemical formula of SiO₂. Typical materials composed of silica include quartz, which contains a structure based on an interlocking SiO₄ tetrahedra (or “honeycomb”) structure where each oxygen atom is shared by two silicon atoms. Hydrophilic silica is typically associated with water molecules in the tetrahedra structure, and has about 7% moisture by weight. Hydrophilic silica may be “fumed” (i.e. produced from a filtration process) or “precipitated” (i.e. produced from a process using an electric current). Hydrophobic silica is useful as a defoamer. For example, in the pulp and paper industry the relatively “sharp” edges of hydrophobic silica may be used to break bubbles on the surface of a holding pond of pulp and water. In the coatings and paint industry, hydrophobic silica may be used to break bubbles that may occur when latex paint is rolled on a surface.

It is generally known to provide for the conversion of hydrophilic silica to hydrophobic silica. Such known conversion is accomplished by the replacement of the water molecules cleaved to the hydrophilic silica with silicone oil. Such conversion is typically conducted in a “one-time” or batch conversion process. Such batch conversion of hydrophilic silica to hydrophobic silica typically involves loading bulk volumes of hydrophilic silica and silicone into a large jacketed vessel, blending the products with a blender, and heating the mix to completion in a large surface area reactor. However, such batch conversion process has several disadvantages including: inefficiencies (e.g. manpower) from running multiple batches, inconsistencies of final product across batches, difficulties in uniformity mixing the hydrophilic silica in such large surface area reactors or such blenders.

Accordingly, it would be advantageous to provide the conversion of hydrophilic silica to hydrophobic silica in a continuous process with a relatively high speed of reaction. It would also be advantageous to provide the conversion of hydrophilic silica to hydrophobic silica in a continuous process with a reduction in manpower. It would also be advantageous to provide a relatively uniform finished product of hydrophobic silica. It would also be advantageous to provide sufficient mixing of hydrophilic silica and silicone in a process to convert hydrophilic silica to hydrophobic silica. It would also be desirable to provide for a hydrophobic silica system and method having one or more of these or other advantageous features.

### SUMMARY

The present invention relates to a process for the continuous production of hydrophobic silica. The process may include mixing hydrophilic silica with silicone in a mixer thereby forming a mixture. The process may also include heating the mixture in a reactor thereby forming hydrophobic silica. The hydrophobic silica may be formed continuously by providing the hydrophilic silica and the silicone.

The present invention also relates to a system for the continuous production of hydrophobic silica. The system may include a mixer for mixing the hydrophilic silica and silicone. The system may also include a reactor for heating the hydrophilic silica and the silicone comprising a channel having a plurality of heating zones, wherein the reactor is in fluid communication with the mixer. The system may also include a storage receptacle for storing the hydrophilic silica, wherein the storage receptacle is in fluid communication with the reactor. The system may be configured for the continuous production of the hydrophobic silica by varying the amounts of hydrophilic silica and silicone provided to the mixer.

The present invention further relates to a method for the continuous production of hydrophobic silica. The system may include a mixer for mixing the hydrophilic silica and silicone. The system may also include a reactor for heating the hydrophilic silica and the silicone comprising a channel having a plurality of heating zones. The method may also include mixing the hydrophilic silica with the silicone in the mixer thereby forming a mixture. The method may also include heating the mixture in the reactor thereby forming hydrophilic silica. The hydrophobic silica may be formed continuously by provision of the hydrophilic silica and the silicone.

### DESCRIPTION OF THE FIGURES

FIG. 1 is a flow diagram of the method for the conversion of hydrophilic silica to hydrophobic silica in a continuous process according to an exemplary embodiment.

FIG. 2 is a flow diagram showing the reactants and the products of the method for the conversion of hydrophilic silica to hydrophobic silica according to an exemplary embodiment.

FIG. 3 is a flow diagram of the method for the conversion of hydrophilic silica to hydrophobic silica according to an exemplary embodiment.

FIG. 4 is a schematic diagram of a system for the conversion of hydrophilic silica to hydrophobic silica in a continuous process according to a preferred embodiment.

FIG. 5 is a schematic view of a filter according to an exemplary embodiment.

FIGS. 6 is a sectional view of a mixer according to an exemplary embodiment.

FIG. 7 is a schematic view of a mixer according to an alternative embodiment.

FIG. 8 is a schematic view of a reactor according to an exemplary embodiment.

FIG. 9 is a schematic view of a heat exchanger according to an exemplary embodiment.

FIG. 10 is a fragmentary sectional view of the heat exchanger according to an exemplary embodiment.

### DETAILED DESCRIPTION OF PREFERRED AND OTHER EXEMPLARY EMBODIMENTS

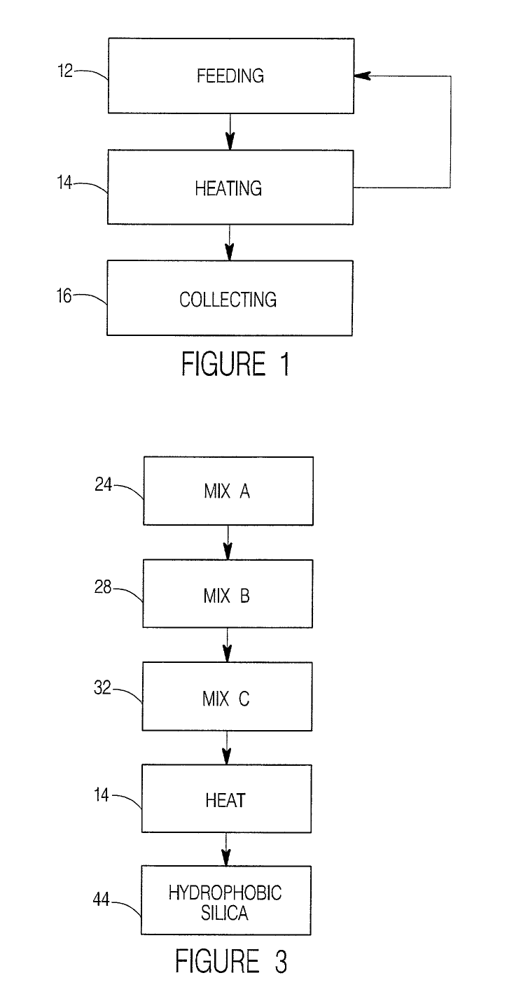

FIG. 1 shows a process for the conversion of hydrophilic silica to hydrophobic silica according to an exemplary embodiment. Referring to FIG. 1, the reaction material of stock or raw hydrophilic silica is fed (step 12) into a feed subsystem 50 of a conversion system 10. The hydrophilic silica is combined with other starting or reaction materials such as silicone. The reaction materials are reacted or heated (step 14) in a heating subsystem 160 of conversion system 10. The resulting reaction product (i.e. hydrophilic silica) is collected (step 16) in a collection subsystem 200 of conversion system 10 for further processing, finishing or shipment.

New reaction materials may be provided to feed system 50 at any time during the conversion of the hydrophilic silica to the hydrophobic silica. Unreacted reaction materials (e.g. hydrophilic silica dust from the starting materials) may be recycled in conversion system 10 for combination with other reaction materials for further reaction in conversion system 10. Thus, conversion system 10 can be run continuously (i.e. does not need to be “shut down” or stopped), and the reaction materials may be continuously loaded into feed system 50 for subsequent reaction.

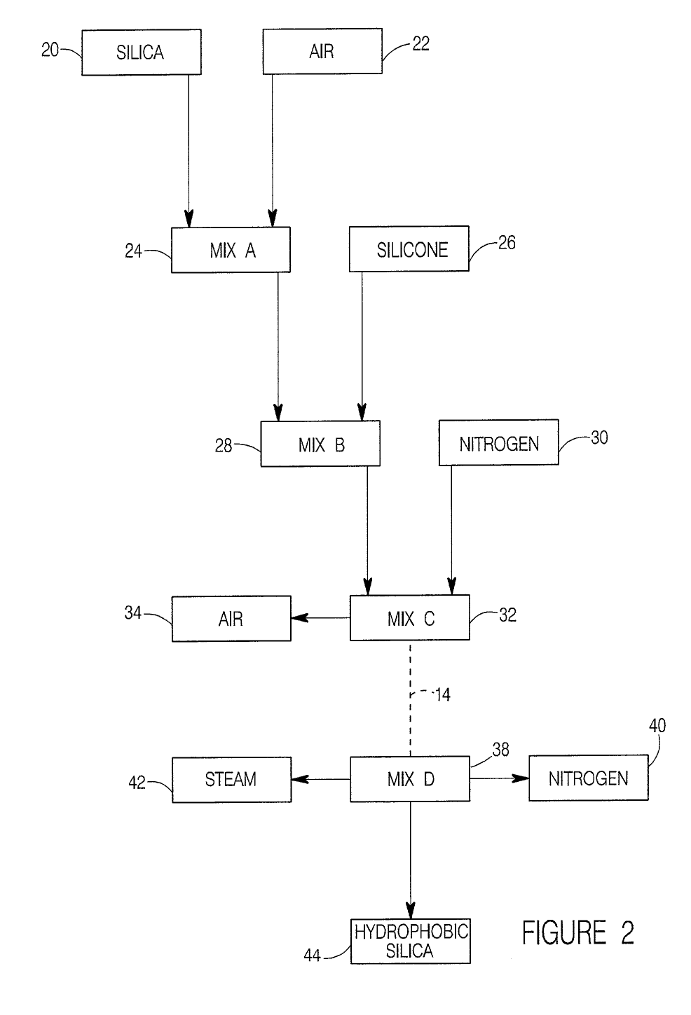

FIG. 2 shows a flow diagram showing the reactants (e.g. hydrophilic silica, silicone, etc.) of the method for the conversion of hydrophilic silica to hydrophobic silica, and the resulting product (i.e. hydrophobic silica). In general, the hydrophilic silica and air are combined with a silicone reactant. The reactants are heated to produce a hydrophobic silica product.

Referring to FIG. 2, raw hydrophilic silica (reactant 20) is combined with air 22 to yield a mix 24. Mix 24 is combined with silicone (reactant 26) to yield a mix 28. An inert gas (shown as nitrogen 30) is combined with mix 28 to yield a mix 32. Air 22 is removed from mix 32 (step 34), and heat is applied to mix 32 (step 14) to yield a mix 38. Mix 38 comprises hydrophobic silica (converted from the hydrophilic silica 20), steam (from the water of hydrophilic silica 20) and nitrogen 30. The inert gas and steam are removed from mix 38 (steps 40 and 42, respectively). A resulting hydrophobic silica product 44 may be collected.

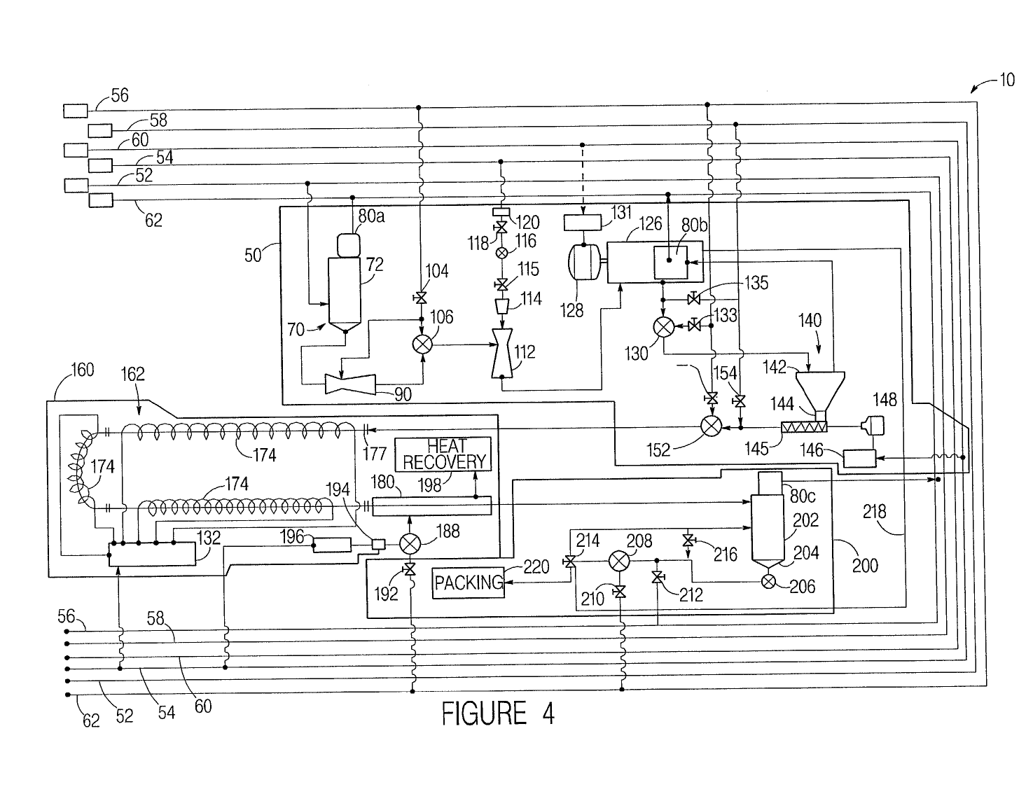

FIG. 3 shows a flow diagram of the method for the conversion of hydrophilic silica to hydrophobic silica according to an exemplary embodiment. FIG. 4 shows a schematic diagram of a system for the conversion of hydrophilic silica to hydrophobic silica in a continuous process according to a preferred embodiment. Conversion system 10 includes three sub-systems: feed system 50 for mixing and dispensing the reactants, heating system 160 for reacting the reactants and recovering excess heat, and finishing or collection system 200 for offtake and packaging of the products. Referring generally to FIGS. 3 and 4, feed system 50 of conversion system 10 provides the reactants (e.g. hydrophilic silica and air) to yield mix 24, the additional reactants (i.e. silicone fluid) to yield mix 28, and still additional materials (e.g. nitrogen) to yield mix 32. Mix 32 is heated (step 14) by heating system 160 to yield mix 38, which is purified (i.e. by removal of nitrogen and steam) (steps 40 and 42, respectively) and collected (step 16) by collection system 200.

Referring to FIG. 4, supplies or sources for the reaction materials are shown as hydrophilic silica line 52 and silicone line 54. A source for fluidizing the materials is shown as air line 56 (also for energizing pumps in conversion system 10) and inert gas or nitrogen line 58. An electrical source for providing electricity to conversion system 10 is shown as electrical line 60. A vacuum source for removing materials is shown as vacuum line 62.

Referring further to FIG. 4, a loading and dispensing system or dump station 70 of feed system 50 is shown. Raw hydrophilic silica (e.g. from silica line 52 or containers of raw material) may be loaded into a collection tank 72 having a tapered bottom or outlet 74. A dust collector or filter (shown as a bag house filter 80a) may be attached to tank 72 for collection of excess dust generated during the loading of the hydrophilic silica in dump station 70.

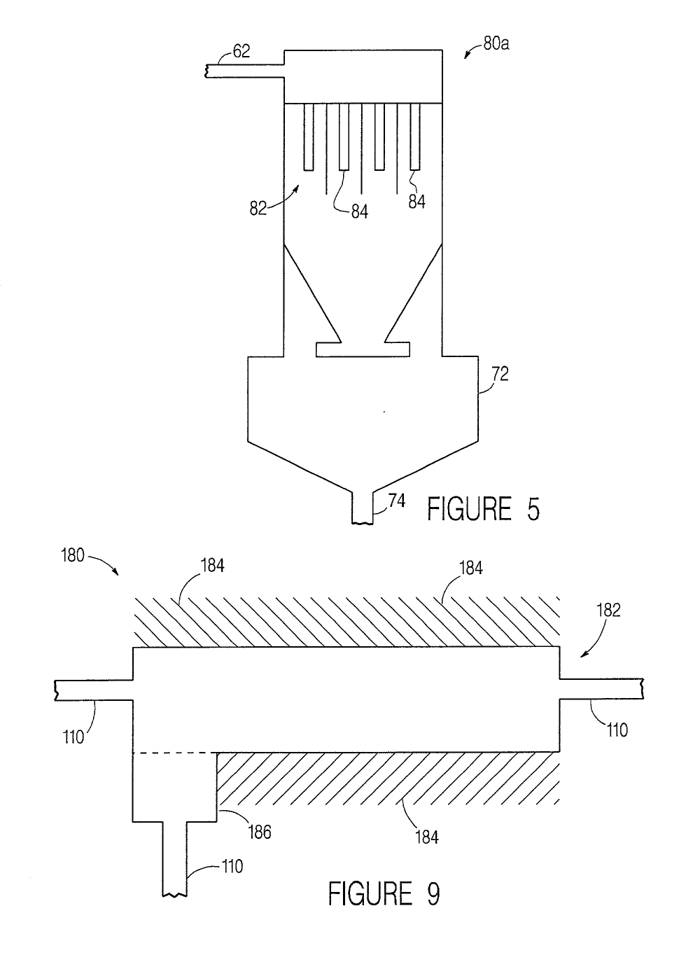

Referring to FIG. 5, the hydrophilic silica dust may be collected in a series of “sock filters” (shown as filter bags 84) in multiple chambers 82 of filter 80a. Bags 84 of filter 80a may include a poly-tetrafluoroethylene (PTFE) membrane. Such collected hydrophilic silica dust may be loaded back into dump station 70 with the next batch of raw material for further reaction as it is accumulated, or at the end of the dumping sequence. To load or drop the collected dust into dump station 70, a reverse pulse blast is directed toward the inside center of the membrane with vacuum of about 1.5 atmospheres of air pressure. The blast tends to cause the dust to “cake” or collect on the membrane of bag 84. The collected dust then falls off into tank 72. According to a particularly preferred embodiment, the filter is a polyester/tetrateck bag house filter model no. HIMAR-03 commercially available from CS&S Filtration of Chattanooga, Tenn.

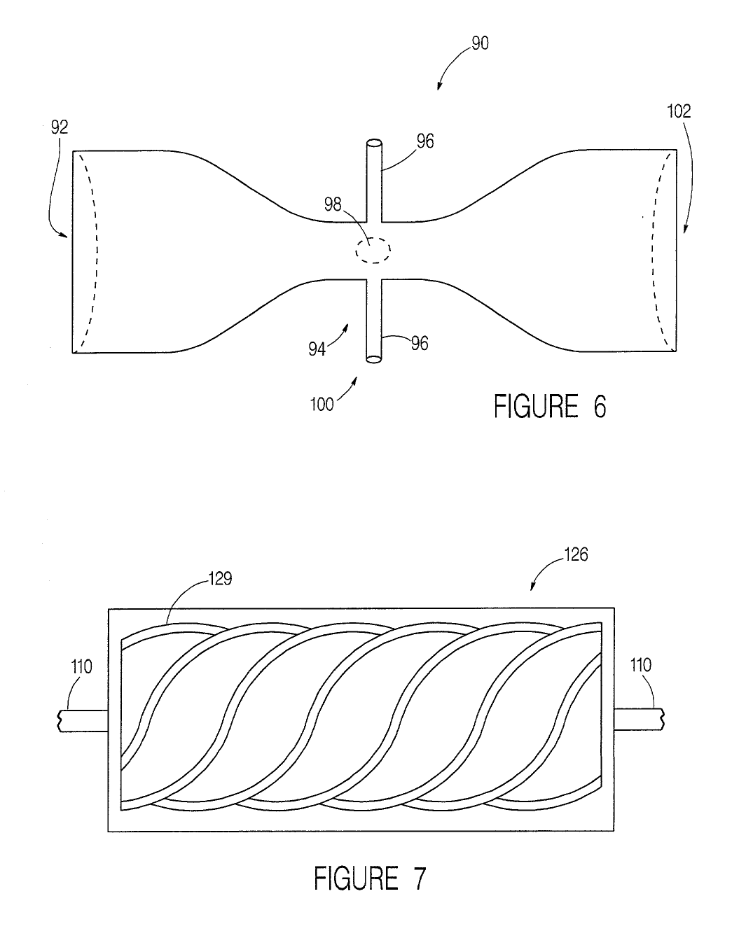

The hydrophilic silica from dump station 70 is fed (e.g. by gravity) through outlet 74 into a mixer (shown as a venturi mixer 90). Referring to FIG. 6, the hydrophilic silica or diluent enters the rear or back of mixer through an orifice injector 92, which may be weight calibrated. Mixer 90 permits the blending of the hydrophilic silica and the air in different proportions or at different rates. Mixer 90 is useful for diluting or mixing concentrated hydrophilic silica (e.g. the concentrate) from silica line 52 with fluidizing air (e.g. the diluent) from air line 56 to yield mix 24. According to an alternative embodiment, a sensor or controller may be used to monitor, regulate or control the proportions/rates of the concentrate and the diluent.

The air is injected into mixer 90 through an inlet 96 at a tapered center 94 of mixer 90. A relatively small volume of the air (compared to the volume of the hydrophilic silica) is injected into mixer 90 at a relatively high velocity. This velocity creates a vacuum at a cyclone eye or venturi 98 in a swirl chamber 100 of mixer 90. The vacuum “sucks” the hydrophilic silica into venturi 98, and blends the hydrophilic silica with the air, thus fluidizing the mixture. According to a preferred embodiment, the hydrophilic silica is a powder having a diameter of about 2 microns (similar to concrete dust), which is “fluidized” or is transported as a fluid or slurry of powder and air in the conversion system. The fluidized hydrophilic silica exits mixer 90 through an outlet port 102. According to a particularly preferred embodiment, the mixer is a venturi mixer model no. VVE-2 commercially available from Vortex Ventures of Houston, Tex.

A valve 104 regulates the amount of air provided to mixer 90, and provides air to energize a pump (shown as a diaphragm pump 106). Pump 106 applies a vacuum on outlet port 102 of mixer 90 to pull the hydrophilic silica through mixer 90 (i.e. a negative pressure on pump 106 pulls the hydrophilic silica powder down from dump station 70 to mixer 90). The air passes over valves (e.g. ball inlet valves) of pump 106 and enters the chambers of pump 106, thus adding the air to mix 24 from mixer 90. According to a preferred embodiment, the inlet of the pump has a diameter of about 2 inches. According to a particularly preferred embodiment, the pump is a diaphragm pump model no. M-8 commercially available from Wilden of Colton, Calif.

Mix 24 is pumped through pump 106 and transport piping or lines 110 into swirl chamber 100 of an “in-line” mixer (shown as a venturi mixer 112). Mix 24 entering mixer 112 is mixed with silicone fluid from a spray injection system 114. Specifically, a pump (shown as a high-pressure piston pump 116) pumps the silicone fluid from silicone line 54 through valve 118 and 115 into spray system 114.

The spray injection system loads a specific amount (e.g. weight, volume, etc.) of the silicone fluid into a container or measuring drum 120, which is regulated by a valve (shown as a calibrated measuring valve 118). The silicone fluid is measured as it is being pumped to drum 120, and is released on the opening of valve 118. The silicone fluid is then drawn into the inlet of pump 116, where it is pumped at a relatively high pressure (e.g. about 15,000 psi of spray pressure) into orifice injector 92 of mixer 112. Injector 92 directs the silicone fluid into swirl chamber 100 of mixer 112. Spray system 114 provides relatively good atomization of the silicone fluid. The atomization acts as a “fog” or mist of silicone fluid that is coated on the hydrophobic silicone powder of mix 24 to yield mix 28.

The air pressure from pump 106 then forces mix 28 through mixer 112 to a mixing tank (shown as a ribbon mixer 126 for the mixing of the slurry/paste/solid of mix 28 by revolution of an elongated helicoid or spiral ribbon 129 of metal). Mixer 126 has a generally horizontal vessel for mixing of mix 28 in a backward and forward motion across the horizontal surface of the vessel. According to alternative embodiments, the mixer may be any type of mixer that provides complete and thorough blending of the slurry, such as a double cone mixer or a rotary cone mixer commercially available from Ling Kwang industrial Co., Ltd. of No. 7-1 Lane 210 Chung Cheng S, Road Yung Kang Shin Tainan Hsien Taiwan Republic of China. According to a particularly preferred embodiment, the mixer is a ribbon mixer commercially available from Aaron Eg. Co. of Bensonville, Ill.

Mixer 126 may be actuated by a motor (shown as a drive motor 128 to turn ribbon 129 of mixer 126) controlled by a standard control relay operator controller 131. According to a particularly preferred embodiment, the motor is a three phase 460 volt 30 horsepower electric shaft alternating current (AC) motor commercially available from Lincoln Motors Co. of Cleveland, Ohio. Controller 131 may control motor 128 for supplying power to mixer 126. In general, controller 131 is a starter or relay to turn motor 128 on and off. Controller 131 may be activated from a controller (shown as an electric control panel 132), which may include a manual override according to an alternative embodiment.

A filter 80b, similar to filter 80a, may collect dust from mixer 126, which may be loaded or dropped back into mixer 126 at certain intervals (e.g. automatically, timed, during or after mixing, etc.). Air may be removed from mix 28 with a vacuum applied to filter 80b by vacuum line 62.

Mix 28 exits mixer 126 and is provided with nitrogen from nitrogen line 58 to yield mix 32. A switch or control (shown as a solenoid valve 135) regulates the amount of nitrogen used to fluidize mix 32 with nitrogen. According to an alternative embodiment, any gas (e.g. air) or inert gas or relatively inflammable gas could be used with or added to the mixtures in the conversion system.

A pump (shown as a diaphragm pump 130 energized with air from air line 56 by an air valve 133) pumps mix 32 into a tube conduit of a weight feeder 140. According to a preferred embodiment, the pump is run on a timed cycle, and the air valve is controlled by a solenoid for the selective filling of the weight feeder with a minimum weight of the mix until a maximum weight of the mix is reached. Pump 130 supplies suction to the discharge port of mixer 126, helping draw mix 32 to pump 130. A slight amount of fluidizing air is introduced to mix 32 as it enters pump 130 and passes over the ball inlet valves of pump 130. As mix 32 enters the chamber of pump 130, slight additional air may be added to further fluidize mix 32. Mix 32 is then pumped through the pump 130 and transport lines 110 into weight feeder 140.

Weight feeder 140 includes three major components: (1) a feed stock bucket or hopper 142; (2) a load cell 144; and (3) a feed screw auger 145. Feed stock hopper 142 receives mix 32 from pump 130. There is an initial fill weight of hopper 142, and adequate swell de-aeration space for mix 32. (According to a preferred embodiment, the hopper is filled to about 75% capacity to provide adequate space for swell de-aeration of the mixture and settling.) Load cells 144 weigh the amount (e.g. weight) of mix 32 in hopper 142. A controller 146 (e.g. in a “gravity mode”) sends a signal to pump 130 to turn off when a predetermined signal representative of the amount of mix 32 in hopper 142 is exceeded (i.e. the “high limit”). During a continuous process, when the amount (e.g. volume) of mix 32 in hopper 142 is decreased to a minimum level, controller 146 (e.g. in a volumetric or refill mode) sends a signal to pump 130 to turn on to refill hopper 142 to the predetermined fill weight.

Weight feeder 140 is also electronically metered by controller 146 to regulate the feed rate of a charging pump (shown as a diaphragm pump 152 energized with air from air line 56 by an air valve 154). On exceeding the high limit amount of mix 32, auger 145 (powered by a motor 148) passes mix 32 into the inlet of pump 152 at a predetermined rate (e.g. 1 lb./min which may vary in speed). Pump 152 preferably runs continuously, and pumps mix 32 through pump 152 and into a heater or continuous reactor 162 of heating system 160.

As shown in FIG. 4, the hydrophilic silica may be removed from weight feeder 140 with vacuum supplied from filter 80b, thus unused materials from mix 32 may be recycled or reused. Additional nitrogen from nitrogen line 58 (regulated by valve 154) may be added to mix 32 at the inlet of pump 152 to compensate for any nitrogen removed by the vacuum applied by filter 80b.

Mix 32 may be pumped by pump 152 to a heater shown as reactor 162. Reactor 162 heats or “bakes” the water that is cleaved to the hydrophilic silica. The water is expelled as steam, and the nitrogen is removed by bag house 80c. Reactor 162 generally includes relatively straight piping sections or high thermal conductive heat dissipation sleeves (shown as a preheating leg 164 and a leg 168) and a heat maintenance curved section (shown as a U-shaped section or leg 166) connected by flange clamp or fitting 177. Control panel 132 may control reactor 162. Each section of legs 164, 166 and 168 may be controlled by a single temperature controller of control panel 132, which may control a high current relay.

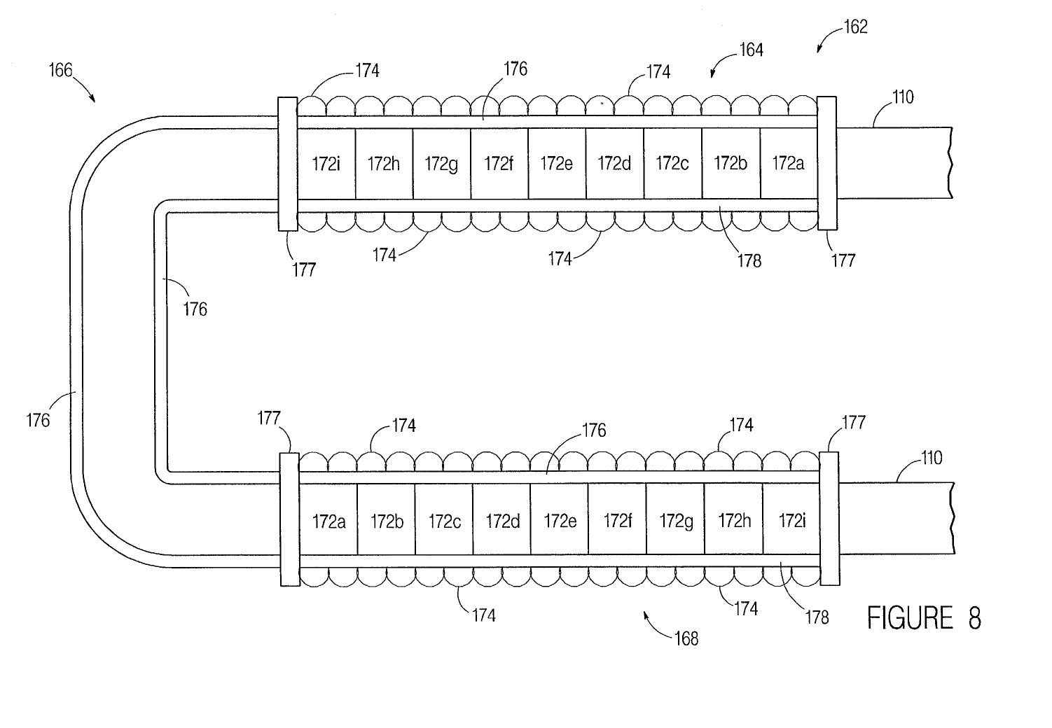

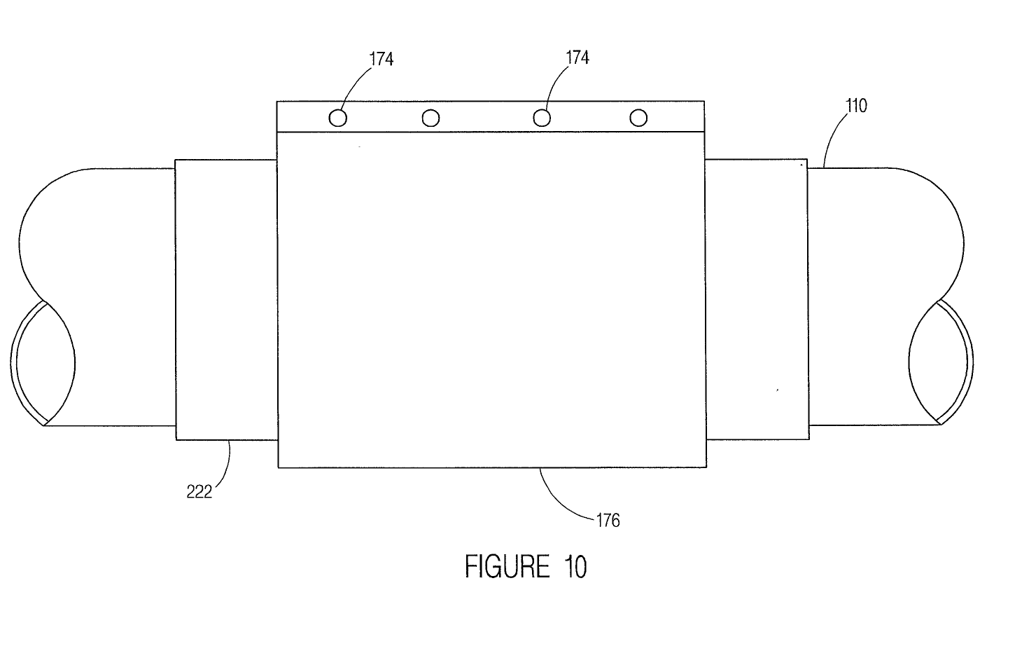

According to a preferred embodiment as shown in FIG. 8, leg 164 includes nine heat zones 172a through 172i for pre-heating the material to a temperature in the range of about 450-600° F., suitably about 500-600° F., suitably about 500-550° F. Zones 172a through 172i may each be wrapped with a relatively high volume of high temperature thermal insulation. Four heaters (shown as a band heater or coil 174) are shown wrapped around each zone of leg 172. Thermocouples may be placed directly on leg 164 in close proximity to coil 174 to improve temperature control. Pipe hangers and support brackets may be used to allow for thermal expansion of legs 164, 166 and 168. As shown in FIG. 10, pipe or line 110 of reactor 162 may include a heat dissipation sleeve 222 to distribute the heat from coil 174. According to a particularly preferred embodiment, the leg for preheating the material has a length of about fifty feet, and the mix is heated in the leg for about 56 seconds, which travels through the leg at a velocity of about 1.125 feet/second.

Referring further to FIG. 8, leg 166 is shown having a curved shape and disposed between legs 164 and 168. A heating element (shown as electric heat trace tape 176) is shown wrapped around leg 166 for heating and maintenance of the temperature of the material in leg 166. Tape 176 may be used to preheat leg 166, or to sustain a constant temperature during transfer of the material from leg 164. Tape 176 may maintain the temperature of the materials in leg 166 at a temperature of about 460-600° F. According to a particularly preferred embodiment, the curved leg has a length of about fifteen feet, and the mix is heated in the leg for about 17 seconds, which travels through the leg at a velocity of about 1.125 feet/second. Referring further to FIG. 8, leg 168 is shown for maintaining the temperature of mix 38 in reactor 162 to a temperature of about 460-600° F., suitably less than about 600° F. Leg 168 has substantially the same structure as leg 164, and like reference numerals shown similar elements.

According to a preferred embodiment, the mix is resident in reactor 162 for less than about 2-3 minutes at a temperature of about 550° F. The resident time of the mix may be increased to run the reaction to further completion. According to an alternative embodiment, the reaction may be run at a relatively lower temperature (e.g. about 460° F.) by increasing the length of each section of the reactor (e.g. by about five times) and increasing the time the mix is resident in the reactor (e.g. about 6 hours). According to a particularly preferred embodiment, the diameter of the legs of the reactor is less than about 2 inches. Without intending to be limited to any particular theory, it is believed that a large diameter may result in a larger heat transfer area. According to a particularly preferred embodiment, the tubing legs, flanges, support brackets and fittings are stainless steel.

Referring to FIG. 9, mix 38 exits leg 168 of reactor 162 and enters a heat exchanger 180. Exchanger 180 includes a section of cooling channel or pipe 182 that includes lateral fins 184, and which is capped with an air duct 186. Air from air line 56 is blown through duct 186 by an air cooling blower fan or pump 188 regulated by a valve 192. Pump 188 is run by an electric variable speed blower motor 194 controlled by a controller 196. The speed of motor 194 may be increased/decreased by controller 196 if the temperature of the material in exchanger 180 is too high/low. Pump 188 supplies cooling air to exchanger 180, and the product process temperature is lowered to a specification above the due point of the finished product (suitably in the range of about 200-300° F., suitably less than about 250° F.). As mix 38 passes through exchanger 180 heat is extracted and recovered by a heat recovery unit 198, such as a vent or exhaust to the offices of a plant or outside the plant. According to an alternative embodiment, the elements of the conversion system are configured to accommodate relatively high temperatures in the event that the heat exchanger is omitted from the conversion system.

Mix 38 exits heat exchanger 180 through line 110, and enters a product recovery collector tank 202 of collection system 200. Tank 202 is a receiver or storage unit for finished product (i.e. hydrophobic-silica) awaiting transport by a transfer diaphragm pump 208. Steam generated from the reaction in reactor 160 may be removed by a filter bag house 80c mounted to tank 202, and recovered by vacuum line 62. According to a preferred embodiment, the bag house is a relatively high temperature bag house.

The hydrophobic silica may be removed from tank 202 by coordinating a rotary air lock 206 with pump 208 (energized by air from air line 56 and regulated by a valve 210). Rotary air lock 206 provides a positive seal at the bottom of tank 202. According to an alternative embodiment, the rotary air lock may be removed from the collection system, depending on the amount of vacuum provided at the filter bag house.

The inlet port of pump 208 supplies “suction” or negative pressure to a tapered discharge port 204 of tank 202, helping draw the hydrophobic silica to pump 208. A slight amount of fluidizing air is introduced to the hydrophobic silica as it enters pump 208, (e.g. by air from air line 56 regulated by a valve 212). The hydrophobic silica may then be pumped through pump 208. According to a preferred embodiment, the inlet port of the diaphragm pump has a diameter of about two inches. According to a particularly preferred embodiment, the pump is a timed pump regulated by a controller such that a predetermined amount of hydrophobic silica is pumped at a predetermined interval (e.g. at a rate of 1 lb./min, turned on every 40 minutes to pump 20 lbs. of hydrophobic silica, etc.)

The hydrophobic silica may be pumped through pump 208 to the specific transport lines regulated by a multi port directional manifold or valve 214. The finished product may be directed to a test port 216 via valve 214, “invasively” removed from collection system 10, and tested for hydrophobicity. Valve 214 includes a set of transfer tubes designed to move the finished product to the packaging operation 220, or to redirect non-finished product back to mixer 126 via a return line 218 (for continuous loading of materials), depending on the results of the test of the product at test port 216. The discharge port of pump 208 may be attached to whichever operation is required for the transportation of the product. If the material at test port 216 is satisfactory, the material (i.e. hydrophobic silica) may be pumped to the packaging operation 220. The hydrophobic silica may be packed “wet” (e.g. pumped into a mixing tank), or may be packed “dry” in relatively large “super sacks,” relatively smaller containers (e.g. 20 lb. bags), storage containers, other holding bins, etc. According to a preferred embodiment, the final product has about 0-1% moisture (some surface moisture may be acceptable).

The controllers of the conversion system may each be a programmable logic controller (PLC) for implementing a control program that provides output signals based on input signals provided by an operator or otherwise acquired. The PLC may have an A/D (analog-to-digital) converter to convert analog signal from a sensor to digital. According to alternative embodiments, other suitable controllers of any type may be included in the control system. For example, controllers of a type that may include a microprocessor, microcomputer or programmable digital processor, with associated software, operating systems and/or any other associated programs to collectively implement the control program may be employed. According to alternative embodiments, the controller and its associated control program may be implemented in hardware, software or a combination thereof, or in a central program implemented in any of a variety of forms. Sensors associated with a controller may be used to monitor a signal representative of a parameter (e.g. flow rates volume, height, heat build-up, leaks, volatility, clogs, errors, etc.). A display (e.g. computer monitor) may be used to monitor the signal from the sensor. The controller may be used to perform an action (e.g. turn on/off release valve, safety vent, cooling system, shut down, alarm, etc.) if any monitored parameter is outside of a predetermined range. A user interface (e.g. keyboard, touch screen, computer, etc.) may be used to control the controller.

### TEST METHODOLOGY

The hydrophobicity of the resulting hydrophobic silica may be determined by a variety of methods. One method includes determining the percent water by introducing the sample into a Mettler Toledo DL31 Karl Fisher Titrator, titrating the sample and calculating the percent water based on the sample weight and the reagent concentration. Another method includes introducing a weighted portion of the resulting hydrophobic silica into a centrifuge tube containing a 40% MeOH/H2O solution or a 20% wt/wt methanol/water solution, agitating, and inspecting for turbidity (generally acceptable hydrophobicity is achieved if there is substantially no turbidity in the sample).

### Experimental

Samples of hydrophobic silica were produced using the system substantially as shown in FIG. 4. Each sample had a hydrophobicity that was generally acceptable. Specifications of the samples are shown in TABLE 1.

TABLE 1

| | | Sample | | |
|---|---|---|---|---|
| Specification | Range | 1 | 2 | 3 |
| Hydrophobicity | 2 Max | 1 | 1 | 1 |
| Appearance | White Powder | Pass | Pass | Pass |
| pH (5% 1:1 IPA/H₂O) | 7.0-10.0 | 7.34 | 8.13 | 9.25 |
| Naphtha Residue | </ = 10 Black Specs | 3 | 1 | 1 |
| Bulk Density | 5-15 Lbs/CuFt | 5.67 | 10.63 | N/A |
| % Water | 3% (Ashland) | 1.07% | 0.82% | 0.67% |
| | 7% Max (all | | | |
| | others) | | | |
| Free Silicone Oil | 0.15% (Ashland) | 0.132 | 0.09 | N/A |
| | 0.30% (all others) | | | |
| 40% Methanol | No Turbidity | Pass | Pass | Pass |
| Hydrophobicity | | | | |
| Wettability Titration | 60-70% | 69.92% | N/A | N/A |
| Packing Density | 21-25 mL | N/A | N/A | 25 mL |
| Wetting Ability | 50% Minimum | N/A | N/A | 70% |

According to a particularly preferred embodiment, the starting material is fumed hydrophilic silica, and the final product is fumed hydrophobic silica. According to a particularly preferred embodiment, the reactor is heated with gas, and according to an alternative embodiment, the reactor is heated with electricity. According to a particularly preferred embodiment, the piping for the conversion system is stainless steel tubular piping having a diameter of about two inches. According to a particularly preferred embodiment, the controller for the weight feeder is a computerized controller with a digital display to regulate parameters including feed rate, refill rate, total weight (tonnage) through the feeder, and display information (e.g. monitor, printout, reports, etc.). According to a particularly preferred embodiment, the weight feeder is a loss weight feeder model no. Disocont VLW commercially available from Schenck/Accurate of Whitewater, Wis. According to a particularly preferred embodiment, the exchanger is a cooling heat exchanger model no. E99-1686L commercially available from Tex-Fin, Inc. of Houston, Tex. According to a particularly preferred embodiment, the fan is an air cooling blower fan commercially available from W. W. Granger of Chicago, Ill. According to a particularly preferred embodiment, the valve is a rotary air valve model no. 253-B-3 commercially available from Wm. W. Meyer of Skokie, Ill. According to a particularly preferred embodiment, the valve is a two way directional model no. 2×3 commercially available from Quality Controls Inc. of Tilton, N.H. According to a particularly preferred embodiment, the motor is a variable speed model no. 5K36PNB commercially available from W. W. Granger of Chicago, Ill. According to a particularly preferred embodiment, the controller is a speed control controller model no. VF-59 commercially available from Toshiba of Houston, Tex.

It is also important to note that the construction and arrangement of the elements of the hydrophobic silica system and method as shown in the preferred and other exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, according to an alternative embodiment chemical dryer. According to another alternative embodiment, the loading of the dump station may be manual or automatic. According to another alternative embodiment, the heat exchanger may be omitted and the “back end components” of the conversion system could directly process or handle the hydrophobic silica. According to another alternative embodiment, the vertical height of the venturi mixer may be about four feet higher than the vertical height of the ribbon mixer. According to another alternative embodiment, the conversion system may be used for the production of other chemicals such as dry silica cements. Accordingly, all such modifications are intended to be included within the scope of the present invention as defined in the appended claims. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the preferred and other exemplary embodiments without departing from the spirit of the present inventions as expressed in the appended claims.

What is claimed is:

1. A process for the continuous production of hydrophobic silica comprising:
mixing hydrophilic silica with silicone in a mixer thereby forming a mixture;
heating the mixture in a reactor thereby forming hydrophobic silica;
wherein the hydrophobic silica is formed continuously by providing the hydrophilic silica and the silicone.

2. The process of claim 1 further comprising mixing the hydrophilic silica with air.

3. The process of claim 1 further comprising spraying the silicone into a rotating funnel of hydrophilic silica.

4. The process of claim 1 further comprising measuring a weight of the mixture before heating the mixture.

5. The process of claim 2 further comprising removing at least a portion of the air from the mixture.

6. The process of claim 1 further comprising adding an inert gas to the mixture.

7. The process of claim 1 further comprising cooling the hydrophobic silica.

8. The process of claim 1 further comprising heating the mixture to a temperature of at least about 500° F.

9. The process of claim 1 further comprising heating the mixture for less than about 3 minutes.

10. The process of claim 1 further comprising continuously recycling at least a portion of the hydrophilic silica.

11. The process of claim 1 further comprising continuously recycling at least a portion of the mixture.

12. The process of claim 6 further comprising removing at least a portion of the inert gas and steam from the hydrophilic silica.

13. The process of claim 1 wherein the hydrophilic silica is fumed silica.

14. The process of claim 1 wherein the hydrophilic silica is precipitated silica.

15. A system for the continuous production of hydrophobic silica comprising:
a mixer for mixing the hydrophilic silica and silicone;
a reactor for heating the hydrophilic silica and the silicone comprising a channel having a plurality of heating zones, wherein the reactor is in fluid communication with the mixer;
a storage receptacle for storing the hydrophilic silica, wherein the storage receptacle is in fluid communication with the reactor;
wherein the system is configured for the continuous production of the hydrophobic silica by varying the amounts of hydrophilic silica and silicone provided to the mixer.

16. The system of claim 15 wherein at least one of the heating zones is configured to reach a temperature of at least about 500° F.

17. The system of claim 15 wherein the reactor is U-shaped and comprises at least two legs.

18. The system of claim 17 wherein the legs of the reactor are less than about 60 feet in length.

19. The system of claim 17 wherein the legs of the reactor have a diameter of less than about 3 inches.

20. The system of claim 15 further comprising a second mixer for mixing the hydrophilic silica and an inert gas.

21. The system of claim 20 further comprising a third mixer for mixing hydrophilic silica and air.

22. The system of claim 21 further comprising wherein at least one of the mixers is a venturi mixer.

23. The system of claim 22 further comprising a sprayer for spraying the silicone into at least one venturi mixer.

24. The system of claim 15 wherein the sprayer is configured to spray the silicone into the eye of the at least one venturi mixer.

25. A method for the continuous production of hydrophobic silica comprising a means for mixing the hydrophilic silica and silicone, and a means for heating the hydrophilic silica and the silicone comprising:
mixing the hydrophilic silica with the silicone in the mixer thereby forming a mixture;
heating the mixture in the reactor thereby forming a hydrophobic silica;
wherein the hydrophobic silica is formed continuously by provision of the hydrophilic silica and the silicone.

26. The method of claim 25 wherein the means for heating comprises a channel having a plurality of heating zones.

27. The method of claim 26 wherein the means for mixing comprises a venturi mixer.

28. The method of claim 27 further comprising testing the hydrophobic silica for hydrophobicity.

29. The method of claim 28 further comprising heating the mixture to a temperature of at least about 500° F. for less than about three minutes thereby reducing the moisture content of the hydrophobic silica to less than about 1%.

30. The method of claim 29 further comprising recycling at least a portion of the mixture and then heating the mixture.
